(19) United States
(12) Patent Application Publication
(10) Pub. No.: US 2023/0164388 A1
(43) Pub. Date: May 25, 2023

(54) INFORMATION PROCESSING APPARATUS, INFORMATION PROCESSING SYSTEM, AND INFORMATION PROCESSING METHOD

(71) Applicant: Hiroki Yoneda, Kanagawa (JP)

(72) Inventor: Hiroki Yoneda, Kanagawa (JP)

(73) Assignee: Ricoh Company, Ltd., Tokyo (JP)

(21) Appl. No.: 18/046,982

(22) Filed: Oct. 17, 2022

(30) Foreign Application Priority Data
Nov. 24, 2021 (JP) 2021-190282

(51) Int. Cl. H04N 21/45; H04N 21/47

(52) U.S. Cl. CPC H04N 21/4532; H04N 21/47

(57) ABSTRACT

An information processing apparatus, an information processing system, and an information processing method. The information processing apparatus identifies a user of an information processing terminal, transmits to the information processing terminal, first screen information for displaying a first screen on a display, the first screen presenting, from among a plurality of applications, a first application available to the user and a second application unavailable to the user in a distinguishable manner, controls execution of the first application selected on the first screen, and in response to selection of the second application on the first screen, transmits to the information processing terminal, second screen information for displaying on the display, a second screen for receiving an operation for enabling use of the second application.

### CROSS-REFERENCE TO RELATED APPLICATIONS

This patent application is based on and claims priority pursuant to 35 U.S.C. § 119(a) to Japanese Patent Application No. 2021-190282, filed on Nov. 24, 2021, in the Japan Patent Office, the entire disclosure of which is hereby incorporated by reference herein.

### BACKGROUND

### Technical Field

The present disclosure relates to an information processing apparatus, an information processing system, and an information processing method.

### Related Art

There are devices that work with applications provided through a network. Some of such devices allow the user to select an application to be executed from an application list screen.

However, not all applications provided through the network are available to each user. For example, in a known method, an application that is not allowed to be used by a certain user is determined based on a license or the like contracted by the user, and the application that is not allowed to be used by the user is not presented to the user as an available application.

### SUMMARY

Embodiments of the present disclosure describe an information processing apparatus, an information processing system, and an information processing method. The information processing apparatus identifies a user of an information processing terminal, transmits to the information processing terminal, first screen information for displaying a first screen on a display, the first screen presenting, from among a plurality of applications, a first application available to the user and a second application unavailable to the user in a distinguishable manner, controls execution of the first application selected on the first screen, and in response to selection of the second application on the first screen, transmits to the information processing terminal, second screen information for displaying on the display, a second screen for receiving an operation for enabling use of the second application.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a configuration of an information processing system according to embodiments of the present disclosure;

FIG. 2 is a diagram illustrating a hardware configuration of a service providing system according to embodiments of the present disclosure;

FIG. 3 is a diagram illustrating an example of a hardware configuration of an image forming apparatus according to embodiments of the present disclosure;

FIG. 4 is a diagram illustrating a functional configuration of the service providing system and the image forming apparatus according to embodiments of the present disclosure;

FIG. 5 is a table illustrating a plan;

FIG. 6 is a sequence diagrams illustrating an example of a process executed by the information processing system;

FIG. 7 is a table illustrating an example of a user contract plan information list;

FIG. 8 is a table illustrating an example of a device contract plan information list;

FIG. 9 is a table illustrating an example of plan mapping data;

FIG. 10 is a diagram illustrating a first display example of an application list screen;

FIG. 11 is a diagram illustrating a second display example of the application list screen;

FIG. 12 is a diagram illustrating an example of an unavailable application notification screen;

FIG. 13 is a table illustrating an example of plan list information;

FIG. 14 is a diagram illustrating a first modified example of the unavailable application notification screen;

FIG. 15 is a diagram illustrating a second modified example of the unavailable application notification screen;

FIG. 16 is a diagram illustrating a third modified example of the unavailable application notification screen;

FIG. 17 is a diagram illustrating a fourth modified example of the unavailable application notification screen;

FIG. 18 is a diagram illustrating an example in which use of a selected application is allowed with a usage restriction;

FIG. 19 is a diagram illustrating a display example of an application list screen on a common setting site;

FIG. 20 is a diagram illustrating a first display example of the unavailable application notification screen on the common setting site; and

FIG. 21 is a diagram illustrating a second display example of the unavailable application notification screen on the common setting site.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

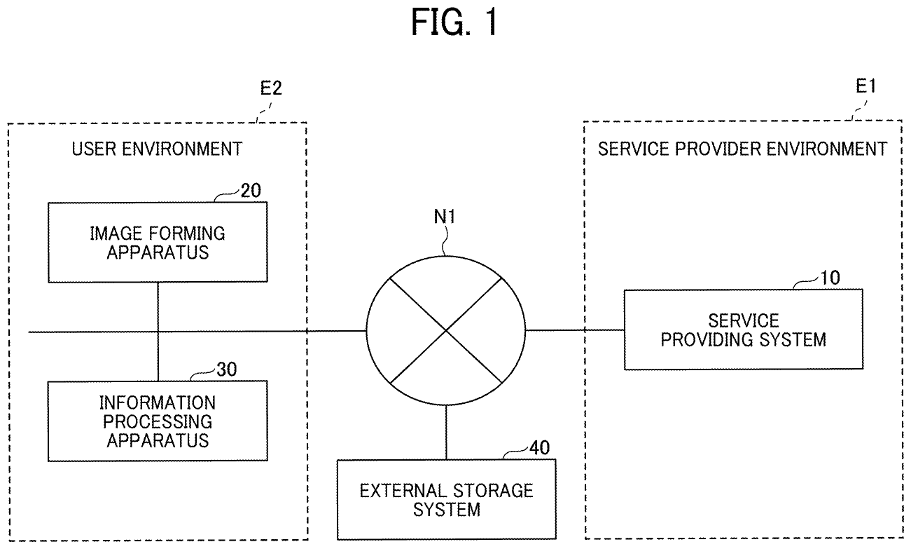

Embodiments of the present disclosure are described below with reference to the drawings. FIG. 1 is a diagram illustrating an example of a configuration of an information processing system according to embodiments of the present disclosure. As illustrated in FIG. 1, the information processing system includes a service providing environment E1, a user environment E2, and one or more external storage systems 40 external to the service provider environment El and the user environment E2. The service providing environment E1, the user environment E2 and the external storage system 40 are communicably connected through a wide area network N1 such as the internet.

The service providing environment E1 is a system environment that provides external services such as cloud services through the network N1. In the present embodiment, a cloud service is used as a specific example of the external service, but the present embodiment may be applied to a service provided through a network, such as services provided by an application service provider (ASP) and web service.

The service providing environment E1 includes a service providing system 10 implemented by one or more information processing apparatuses (computers). The service providing system 10 provides a certain service through the network N1. For example, the service providing system 10 provides a service of executing an application defined in advance as a workflow on image data generated by scanning a document with an image forming apparatus 20 in the user environment E2. Further, the service providing system 10 provides a service of printing the electronic files stored in the external storage system 40 by the image forming apparatus 20 by executing an application defined in advance as a workflow.

The user environment E2 is, for example, a system environment in a company or the like of a user, who is the user of the image forming apparatus 20. The user environment E2 includes one or more image forming apparatuses 20 and information processing apparatuses 30. The image forming apparatus 20 and the information processing apparatus 30 are each connected to the network N1 through a network such as a local area network (LAN).

The image forming apparatus 20 includes a print function and a scan function. Note that the image forming apparatus 20 may be a multifunction peripheral or the like including a copy function, a facsimile communication function, or the like, in addition to the print function and the scan function.

The information processing apparatus 30 is, for example, a personal computer (PC) or a smart device.

The external storage system 40 is a computer system that provides a cloud service, such as a storage service (or online storage) through the network N1. The storage service is a service that rents out a storage area in the external storage system 40. For example, the storage area is used as a storage destination (upload destination) of the electronic file to be processed in the workflow. Also, the electronic file stored in the storage area is downloaded as input data for the workflow.

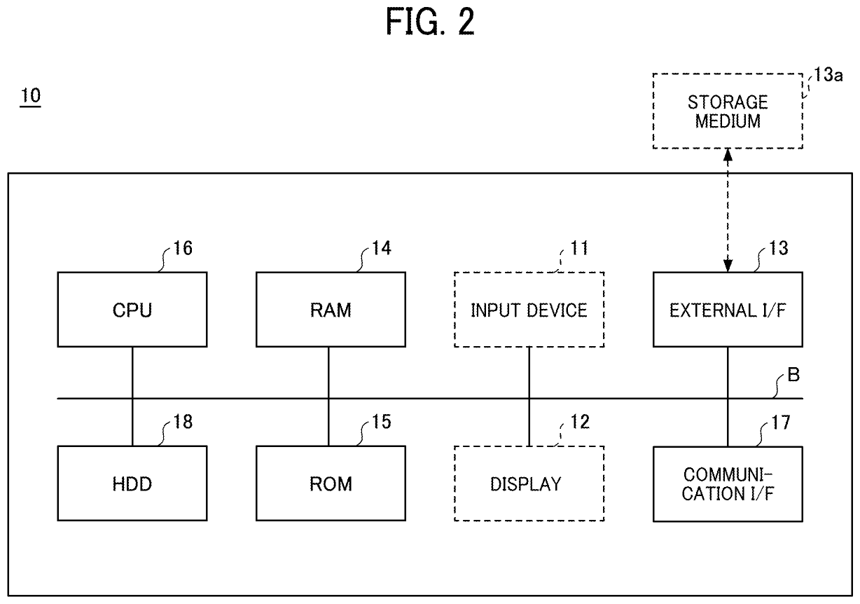

FIG. 2 is a diagram illustrating a hardware configuration of the service providing system 10 according to embodiments of the present disclosure. As illustrated in FIG. 2, the service providing system 10 includes an input device 11, a display 12, an external interface (I/F) 13, a random access memory (RAM) 14, a read only memory (ROM) 15, a central processing unit (CPU) 16, a communication I/F 17, a hard disk drive (HDD) 18, and the like, connected to each other through a bus B. Note that the input device 11 and the display 12 may be connected to the bus B optionally.

The input device 11 includes a keyboard, a mouse, and a touch panel to enable the user to input various operations to cause output of operation signals. The display 12 includes a display panel and the like and displays the processing result produced by the service providing system 10.

The communication I/F 17 connects the service providing system 10 to various networks. Thereby, the service providing system 10 performs data communication through the communication I/F 17.

The HDD 18 is an example of a non-volatile storage device that stores programs and data.

The stored programs and data include an operating system (OS), which is basic software that controls the entire service providing system 10, and software that provides various functions on the OS.

The service providing system 10 may use a drive device, for example, a solid state drive (SSD) using flash memory as a recording medium instead of the HDD 18.

The external I/F 13 is an interface with an external device. Examples of the external device include a storage medium 13a. The service providing system 10 reads and writes from or to the storage medium 13a through the external I/F 13. Examples of the storage medium 13a include a flexible disk, a compact disc (CD), a digital versatile disc (DVD), a secure digital (SD) memory card, and a universal serial bus (USB) memory.

The ROM 15 is an example of a nonvolatile semiconductor memory (storage device) capable of storing the program and data even when the power is not supplied. The ROM 15 stores programs and data such as a basic input output system (BIOS), which is executed when the service providing system 10 starts up, OS settings, and network settings. The random access memory (RAM) 14 is an example of a volatile semiconductor memory (storage device) that temporarily stores programs and data.

The CPU 16 is an arithmetic unit that implements the overall control and functions of the service providing system 10 by reading programs and data from storage devices such as the ROM 15 and the HDD 18 onto the RAM 14 and executing processing according to the read programs and data.

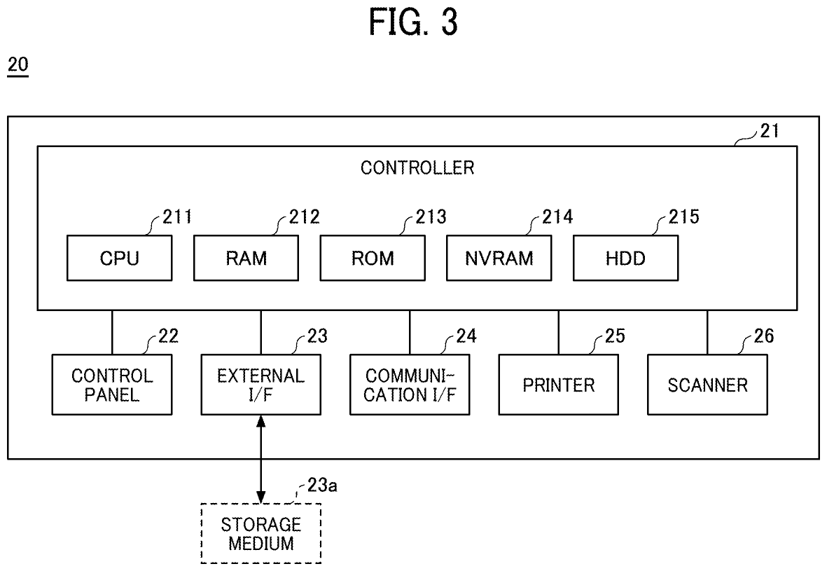

FIG. 3 is a diagram illustrating an example of a hardware configuration of the image forming apparatus 20 according to embodiments of the present disclosure. As illustrated in FIG. 3, the image forming apparatus 20 includes a controller 21, a control panel 22, an external I/F 23, a communication I/F 24, a printer 25 and a scanner 26. The controller 21 includes a CPU 211, a RAM 212, a ROM 213, a non-volatile random access memory (NVRAM) 214, and an HDD 215. The ROM 213 stores various programs and data. The RAM 212 temporarily stores programs and data. The NVRAM 214 stores, for example, settings information and the like. The HDD 215 stores various programs and data.

The CPU 211 reads out programs, data, settings information, and the like from the ROM 213, the NVRAM 214, the HDD 215, and the like onto the RAM 212 and executes processing, thereby implementing control and functions of the image forming apparatus 20 as a whole.

The control panel 22 includes an input unit that receives user input, and a display unit that displays various information. The external I/F 23 is an interface with the external device. The external device is, for example, a storage medium 23a or the like. The image forming apparatus 20 reads and writes from or to the storage medium 23a through the external I/F 23. The storage medium 23a is, for example, an integrated circuit (IC) card, flexible disk, CD, DVD, SD memory card, USB memory, or the like.

The communication I/F 24 connects the image forming apparatus 20 to the network N1. The image forming apparatus 20 performs data communication through the communication I/F 24. The printer 25 is a printing device for printing print data. The scanner 26 is a reading device for reading an original and generating an image file (electronic file).

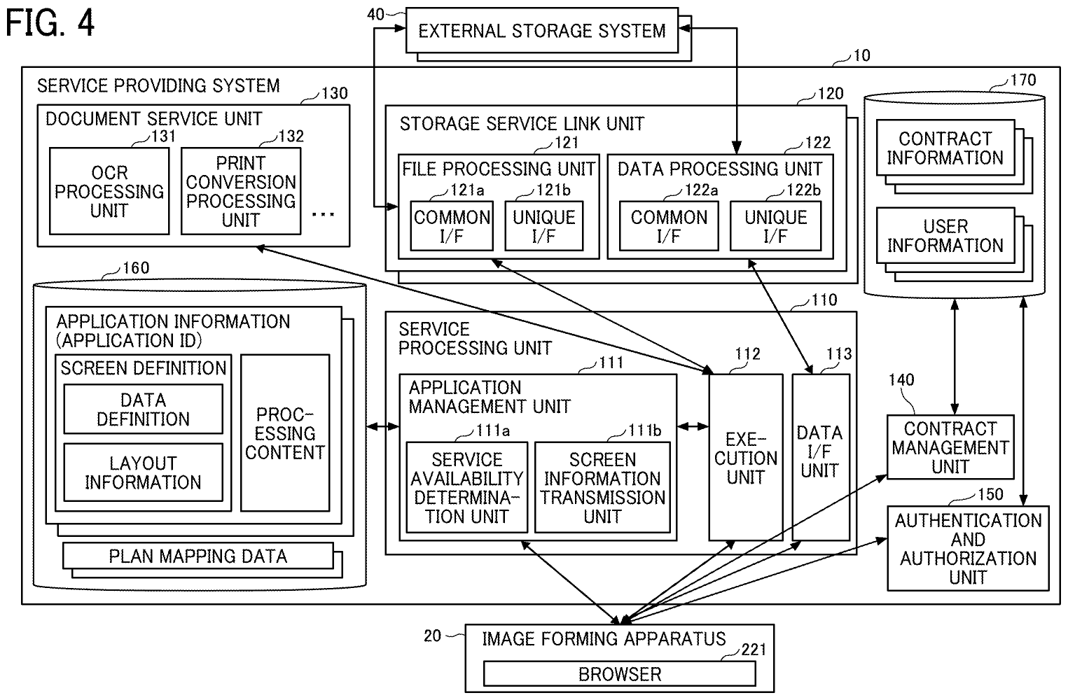

FIG. 4 is a diagram illustrating a functional configuration of the service providing system 10 and the image forming apparatus 20 according to embodiments of the present disclosure.

The image forming apparatus 20 includes a browser 221. The browser 221 is implemented by, for example, processing executed by the CPU of the control panel 22 according to one or more programs installed in the control panel 22 of the image forming apparatus 20. The browser 221 executes Hyper Text Transfer Protocol (HTTP) communication with the service providing system 10. The browser 221 displays a web page provided by the service providing system 10. The browser 221 transmits a request to the service providing system 10 in accordance with the user's operation on the web page, and controls the image forming apparatus 20 in accordance with the operation.

The service providing system 10 includes a service processing unit 110, a storage service link unit 120, a document service unit 130, a contract management unit 140 and an authentication and authorization unit 150. Each of these units is implemented by a process executed by the CPU 16 according to one or more programs installed in the service providing system 10. The service providing system 10 also includes an application information storage unit 160 and a contract and user information storage unit 170. Each of these storage units is implemented by, for example, the HDD 18 or a storage device connected to the service providing system 10 through the network.

The authentication and authorization unit 150 authenticates and authorizes a user of the image forming apparatus 20. In other words, the authentication and authorization unit 150 specifies the successfully authenticated user (the user who logs in to the service providing system 10) as the user of the image forming apparatus 20 (the user who uses the image forming apparatus 20). The authentication and authorization unit 150 identifies a plan applied to the logged-in user. The plan is an option regarding the application usage form, usage restriction, and the like.

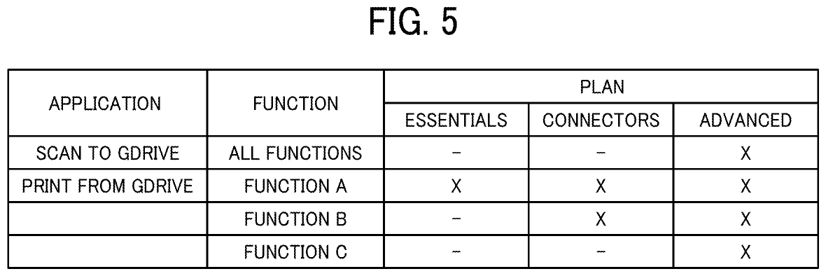

FIG. 5 is a table illustrating the plan. FIG. 5 illustrates the functions available for each application for each plan. The example of FIG. 5 illustrates an example in which three plans of “Essentials”, “Connectors”, and “Advanced” are prepared. The “Advanced” plan includes all the functions of the “Scan to GDrive” application and all the functions of the “Print from GDrive” (function A, function B, and function C) as available functions. The “Connectors” plan includes functions A and B of “Print from GDrive” as available functions. The “Essentials” plan includes function A of “Print from GDrive” as available function. Therefore, the relationship of each plan for the range of available functions is “Advanced”>“Connectors”>“Essentials”, and the range available in the higher plan includes the range available in the lower plan.

The plan is contracted for each user or each image forming apparatus 20. The plan applied to a certain user is the plan contracted in advance for the user or the image forming apparatus 20 used by the user. Each user is allowed to use the application within the usage mode and usage restriction according to the plan applied to the user. There may be a user who does not have the plan contracted. In addition, there may be an image forming apparatuses 20 that have not contracted for the plan. In the case a user without a contracted plan uses the image forming apparatus 20 without a contracted plan, there is no plan applicable to the user.

The contract management unit 140 executes processing related to contracting the plan or modifying the contracted plan.

The service processing unit 110 includes an application management unit 111, an execution unit 112 and a data I/F unit 113.

The application management unit 111 returns a response based on application information stored in the application information storage unit 160 in response to a request from the browser 221 of the image forming apparatus 20. The application information is information defined for each application. In the present embodiment, the application refers to a workflow application. The workflow application is implemented by an ordered combination of multiple components. The component is a program that is a part of the workflow application. The application is created by preparing a plurality of types of components in advance and defining the execution order of the components. The application information of an application includes screen definition, processing content, and the like. The screen definition is definition information regarding a screen for receiving settings regarding the application. The processing content is definition information indicating the processing content of the application, and includes, for example, the execution order of components included in the application, initial values of settings information regarding each component, and the like. For example, the application management unit 111 generates HyperText Markup Language (HTML) format screen information based on the screen definition included in the application information, and transmits the screen information to the browser 221.

The application management unit 111 includes a service availability determination unit 111a and a screen information transmission unit 111b.

The service availability determination unit 111a determines which application is available (allowed to be used) and which is not (not allowed to be used) in the plan applied to the logged-in user. In the case the logged-in user is not contracted to any plan (there is no plan that applies to the logged-in user), the service availability determination unit 111a does not determine whether the application is available.

The screen information transmission unit 111b generates screen information indicating the screen to be displayed on the browser 221 and transmits the generated screen information to the browser 221. For example, the screen information transmission unit 111b transmits screen information of an application list screen (hereinafter referred to as “application list screen information”) that allows selection of the application to be executed from among a plurality of applications and transmits the application list screen information to the browser 221. The screen information transmission unit 111b generates the application list screen information identifying the application allowed to be used by the logged-in user and the applications that is not allowed to be used based on the determination result of the service availability determination unit 111a. The screen information defines a layout of the screen and processing according to the operation of display components on the screen. For example, the screen information may be defined using HTML, scripts, or the like.

The execution unit 112 controls execution of the application selected on the application list screen in response to a request from the browser 221 of the image forming apparatus 20. Specifically, the execution unit 112 acquires the processing details of the application selected on the application list screen from the application management unit 111, and controls execution of the application based on the acquired processing details.

In the process of controlling application execution, the execution unit 112 requests the document service unit 130 or the storage service link unit 120 to perform processing.

In response to a request from the browser 221 of the image forming apparatus 20, the data I/F unit 113 requests the data processing unit 122 of the storage service link unit 120 to acquire a list of files.

Note that the application management unit 111, the execution unit 112, and the data I/F unit 113 may communicate with the image forming apparatus 20 independently, or the service processing unit 110 as a whole may communicate with the image forming apparatus 20 using a common communication path (for example, a socket or the like) established with the image forming apparatus 20.

In response to a request from the execution unit 112 or the data I/F unit 113, the storage service link unit 120 requests the external storage system 40 to execute processing according to the request. As illustrated in FIG. 4, the storage service link unit 120 includes a file processing unit 121 and a data processing unit 122.

The file processing unit 121 includes a common I/F 121a and a unique I/F 121b defining Application Programming Interfaces (APIs) for operating electronic files stored in the external storage system 40. The common I/F 121a is an API group common to multiple types of external storage systems 40. The unique I/F 121b is an API group unique to each external storage system 40.

The data processing unit 122 includes a common I/F 122a and a unique I/F 122b defining APIs for acquiring metadata such as document information of electronic files stored in the external storage system 40. The common I/F 122a is an API group common to multiple types of external storage systems 40. The unique I/F 122b is an API group unique to each external storage system 40.

The document service unit 130 is a group of components that make up an application. FIG. 4 illustrates an optical character recognition (OCR) processing unit 131 and a print conversion processing unit 132 as examples of components. The OCR processing unit 131 is a component that receives image data, executes OCR processing on the image data, and outputs the result of the OCR processing.

The print conversion processing unit 132 is a component that receives electronic data, converts the electronic data into a format for printing (for example, Portable Document Format (PDF)), and outputs data resulting from the conversion. Other components include a component that distributes data to a predesignated external storage system 40, a component that downloads data from the external storage system 40, and the like. The components may be added at any time by development.

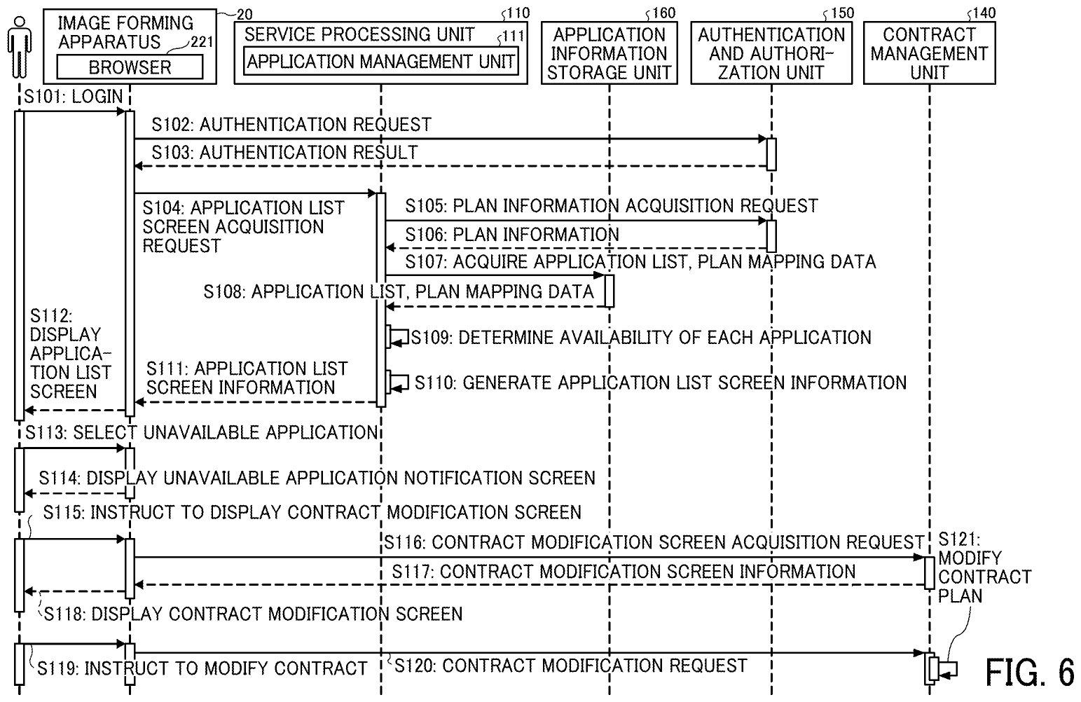

The process executed by the information processing system is described below. FIG. 6 is a sequence diagrams illustrating an example of a process executed by the information processing system.

In step S101, the user performs a login operation on the login screen displayed by the browser 221 of the image forming apparatus 20 to be operated by the user (hereinafter referred to as the “target image forming apparatus 20”), enters the authentication information, and the browser 221 transmits an authentication request including the authentication information to the service providing system 10 in step S102.

The authentication information may be a user ID and password, a card ID read from a card, biometric information, or other information.

In response to receiving the authentication request, the authentication and authorization unit 150 of the service providing system 10 performs authentication by comparing the authentication information included in the authentication request with the correct authentication information stored for each user in the contract and user information storage unit 170, and transmits the authentication result to the browser 221 in step S103. For a successful authentication, the authentication result includes, together with the information indicating the success of the authentication, identification information (hereinafter referred to as “login user ID”) of a user successfully authenticated (that is, a user identified as a login user by the authentication and authorization unit 150).

Based on the successful authentication, the browser 221 executes step 5104. In step S104, the browser 221 transmits an application list screen acquisition request to the service providing system 10. In response to receiving the acquisition request, the application management unit 111 of the service providing system 10 requests the authentication and authorization unit 150 to acquire plan information indicating a plan applied to the logged-in user in step S105. The authentication and authorization unit 150 refers to the contract plan information list included in the contract information stored in the contract and user information storage unit 170, and identifies the plan information (hereinafter referred to as “target plan information”) to be applied to the logged-in user, and transmits the target plan information to the application management unit 111 in step S106. The contract plan information list included in the contract plan information may be associated with the user or may be associated with the image forming apparatus 20. Hereinafter, the contract plan information list associated with the user is referred to as a “user contract plan information list”, and the contract plan information list associated with the image forming apparatus 20 is referred to as a “device contract plan information list”. The user contract plan information list and device contract plan information list are simply referred to as the “contract plan information list”, in the case the two contract plan information lists are not distinguished.

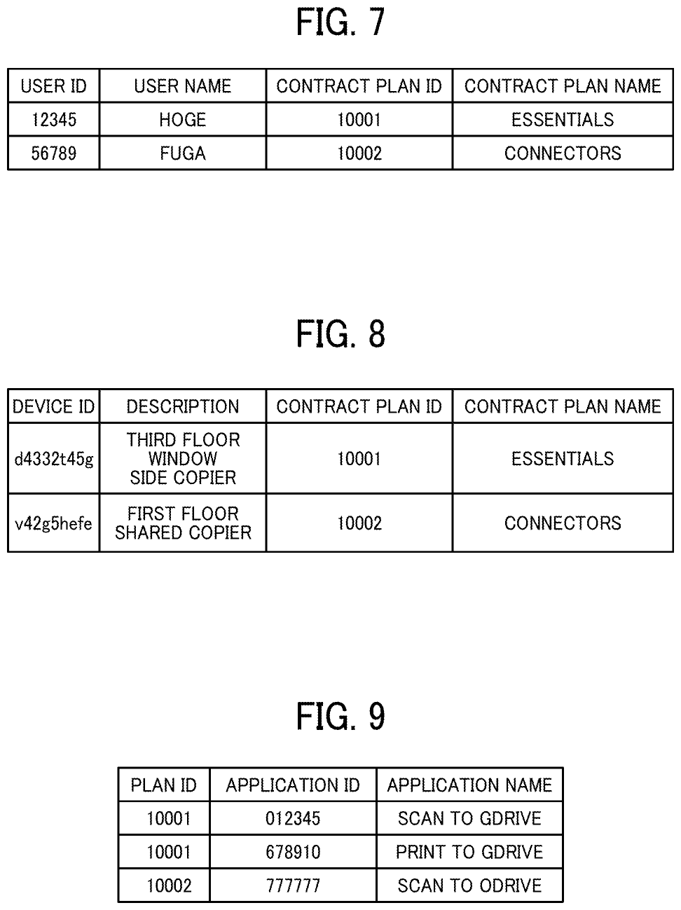

FIG. 7 is a table illustrating an example of a user contract plan information list. As illustrated in FIG. 7, the user contract plan information list includes user ID, user name, contract plan ID, contract plan name, and the like for each user.

The user ID is identification information of a user related to the contract plan. The user name is a name of the user. The contract plan ID is identification information of the contract plan associated with the user by the contract. The contract plan name is the name of the contract plan.

FIG. 8 is a table illustrating an example of a device contract plan information list. As illustrated in FIG. 8, the device contract plan information list includes, for each image forming apparatus 20, a device ID, a description, the contract plan ID, the contract plan name, and the like.

The device ID is identification information of the image forming apparatus 20 associated with the contract. The description is information describing the image forming apparatus 20. The contract plan ID is identification information of the contract plan associated with the image forming apparatus 20 by the contract. The contract plan name is the name of the contract plan.

For example, in the case the user contract plan information list (illustrated in FIG. 7) is stored in the contract and user information storage unit 170, the authentication and authorization unit 150 identifies, as target plan information, the contract plan information (contract plan ID and contract plan name) associated with the user ID of the logged-in user in the user contract plan information list in FIG. 7.

Alternatively, in the case the device contract plan information list (illustrated in FIG. 8) is stored in the contract and user information storage unit 170, the authentication and authorization unit 150 identifies the contract plan information (contract plan ID and contract plan name) associated with the device ID of the target image forming apparatus 20 in the device contract plan information list (FIG. 8) as the target plan information. Note that the device ID of the target image forming apparatus 20 may be transmitted from the browser 221 to the service providing system 10 before step S104.

Alternatively, both the user contract plan information list (FIG. 7) and the device contract plan information list (FIG. 8) may be stored in the contract and user information storage unit 170. In this case, the authentication and authorization unit 150 acquires the contract plan information corresponding to the user ID of the logged-in user or the contract plan information corresponding to the device ID of the target image forming apparatus 20 from the user contract plan information list (FIG. 7) or the device contract plan information list (FIG. 8). In the case one type of contract plan information is acquired, the authentication and authorization unit 150 identifies the contract plan information as the target plan information. In the case two types of contract plan information are acquired, the authentication and authorization unit 150 identifies one of the contract plan information (for example, contract plan information associated with the user ID of the logged-in user, or contract plan information related to a plan with a wider range of available functions) as the target plan information.

In the case the contract plan information associated with either the user ID of the logged-in user or the device ID of the target image forming apparatus 20 is not identified, the authentication and authorization unit 150 determines that there is no target plan information. In this case, the authentication and authorization unit 150 transmits information indicating that there is no target plan information to the application management unit 111 in step S106.

Following step S106, in steps S107 and S108, the application management unit 111 acquires an application list and plan mapping data from the application information storage unit 160. The application list is a list of application IDs and the like of each application whose application information is stored in the application information storage unit 160. The plan mapping data is data that indicates the correspondence between the plan and the applications that can be used by that plan.

FIG. 9 is a table illustrating an example of the plan mapping data. As illustrated in FIG. 9, the plan mapping data includes the application ID and the application name in association with the plan ID. The application ID and application name associated with the plan ID indicate the application ID and application name of the application that can be used in the contract plan associated with the contract plan ID.

In addition, when there is no target plan information (when there is no plan applied to the logged-in user), the plan mapping data may not be acquired.

In step S109, when the target plan information is identified, the service availability determination unit 111a of the application management unit 111 determines whether each application related to the application list is allowed to be used by the logged-in user based on whether each application ID included in the application list is associated with the plan ID of the target plan in the plan mapping data. The service availability determination unit 111a determines that the application associated with the application ID associated with the plan ID of the target plan in the plan mapping data is allowed to be used by the logged-in user. Alternatively, the service availability determination unit 111a determines that the logged-in user is not allowed to use the application associated with the application ID that is not associated with the plan ID of the target plan in the plan mapping data. The service availability determination unit 111a inputs the determination result (information indicating whether or not each application is allowed to be used) to the screen information transmission unit 111b.

In step S110, the screen information transmission unit 111b generates screen information of the application list screen (application list screen information) for selecting the application to be executed from the applications related to the application list, based on the application list. In the case the target plan information is identified, the screen information transmission unit 111b generates the application list screen information enabling identification of applications determined to be available and applications determined to be unavailable based on the result of determination by the service availability determination unit 111a. Alternatively, in the case no target plan information is identified, the screen information transmission unit 111b generates application list screen information enabling execution of all applications included in the application list. However, execution of some or all applications may be restricted based on access control different from the contract plan.

In step S111, the screen information transmission unit 111b transmits the generated application list screen information to the browser 221. In response to receiving the application list screen information, the browser 221 displays the application list screen based on the application list screen information in step S112.

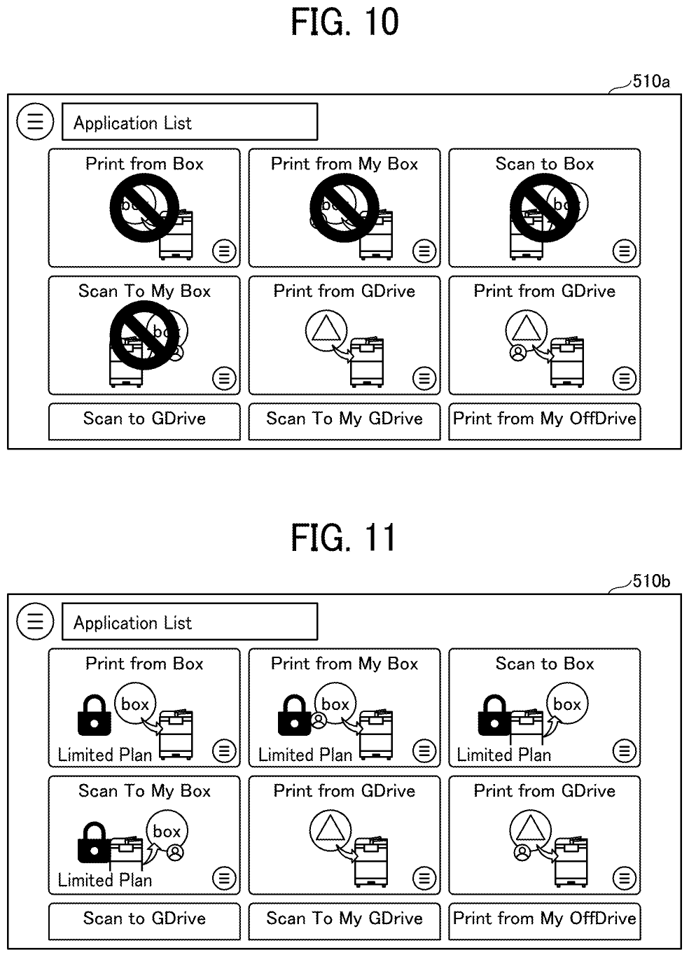

FIG. 10 is a diagram illustrating a first display example of the application list screen. As illustrated in FIG. 10, the application list screen 510a includes a button for receiving an instruction to execute the application for each application included in the application list. In FIG. 10, prohibition marks (circles with diagonal lines) are displayed on the buttons of applications that the logged-in user is not allowed to use. The available applications and unavailable applications are distinguished according to the presence or absence of the prohibition mark. The prohibition mark is generated by the screen information transmission unit 111b together with the application list screen information.

FIG. 11 is a diagram illustrating a second display example of the application list screen. Similar to the application list screen 510a of FIG. 10, an application list screen 510b illustrated in FIG. 11 includes the button for receiving the instruction to execute the application for each application included in the application list. Unlike the application list screen 510a, on the application list screen 510b, a lock mark is displayed to indicate that the application is not allowed to use. The available applications and unavailable applications are distinguished based on the presence or absence of the lock mark. The lock mark is generated by the screen information transmission unit 111b together with the application list screen information. The lock mark may be better compared to the prohibition mark, in emphasizing that the application is not allowed to be used.

Note that the available applications and unavailable applications may be distinguished from each other by other marks or display modes. Hereinafter, the application list screen 510a or the application list screen 510b is referred to as an “application list screen 510” when not distinguished from each other.

The buttons with the prohibition mark on the application list screen 510a and the buttons with the lock mark on the application list screen 510b (hereinafter collectively referred to as “unavailable application button”) are not grayed out and possible to receive an operation by the user.

In response to the pressing of any of the unavailable application buttons by the logged-in user in step S113, the browser 221 displays an unavailable application notification screen based on the definition of the application list screen information (for example, defined by a script or the like) in step S114. The screen information of the unavailable application notification screen is included in the application list screen information. In other words, the screen information transmission unit 111b generates the screen information of the unavailable application notification screen when generating the application list screen information in step S110. Further, in step S111, the screen information transmission unit 111b transmits the screen information of the unavailable application notification screen along with the transmission of the application list screen information. The application list screen information may not include the screen information of the unavailable application notification screen. In this case, the browser 221 transmits an acquisition request for the unavailable application notification screen to the screen information transmission unit 111b in response to operation of the unavailable application button. The screen information transmission unit 111b transmits the screen information of the unavailable application notification screen to the browser 221 in response to the acquisition request.

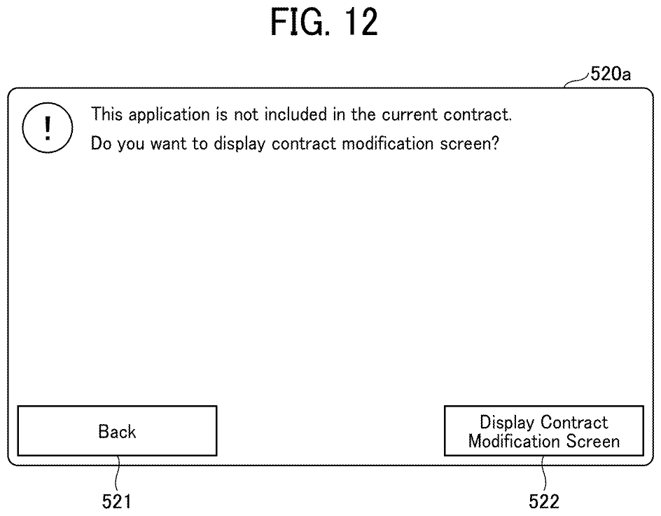

FIG. 12 is a diagram illustrating an example of an unavailable application notification screen. As illustrated in FIG. 12, the unavailable application notification screen 520a includes a message indicating that the selected application (hereinafter referred to as “selected application”) is not allowed to be used in the currently contracted plan (plan applied to the logged-in user), a button 521 and a button 522. The logged-in user perceives that the selected application is not allowed to be used due to the limitation of the contracted plan by referring to the message. The button 521 is a button for receiving an instruction to return to the application list screen 510. The button 522 is a button for receiving an instruction to display a contract modification screen. The contract modification screen is a screen for receiving an instruction to modify the contract plan. The unavailable application notification screen and the contract modification screen are examples of screens for receiving an operation for enabling usage of the selected application.

In response to pressing by the logged-in user of the button 522 to input an instruction to display the contract modification screen in step S115, the browser 221 transmits a contract modification screen acquisition request to the service providing system 10 in step S116. In step S117, the contract management unit 140 of the service providing system 10 refers to plan list information stored in the contract and user information storage unit 170, generates the screen information for contract modification screen (hereinafter referred to as “contract modification screen information”), and transmits the contract modification screen information to the browser 221.

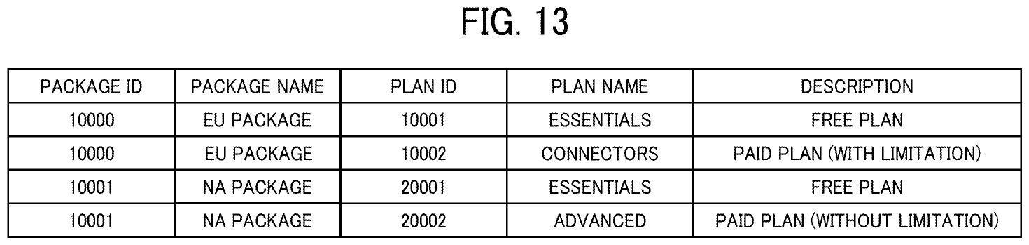

FIG. 13 is a table illustrating an example of the plan list information. The example of FIG. 13 illustrates an example in which the plan is set for each package. The package is a sales unit of an application group including a set of one or more applications. Multiple plans may be set for one package.

One row in FIG. 13 corresponds to one plan. Each row includes a package ID, package name, plan ID, plan name and description. The package ID is identification information of the package. The applications included in each package are managed separately. FIG. 13 includes multiple rows with a common package ID. The multiple rows indicate different plans for the same package. The package name is a name of the package.

The plan ID is identification information of the plan. The plan name is a name of the plan. The description is description of the plan.

As illustrated in FIG. 13, the plan IDs may be different for the same plan name. For example, the plan ID for the Essentials plan for the EU package is 10001, and the plan ID for the Essentials plan for the NA package is 20001. The plan ID is different for each combination of package and plan name, which indicates that the plan is different for each combination of package and plan name. The contract management unit 140 generates the contract modification screen information so as to include options for each plan ID.

In response to receiving the contract modification screen information, the browser 221 displays the contract modification screen based on the contract modification screen information in step S118. The contract modification screen is configured, for example, to enable selection of the plan to contract from a plurality of plans.

In response to receiving selection of the plan by the logged-in user using the contract modification screen in step S119, the browser 221 transmits a contract modification request including the plan ID and plan name of the plan to the contract management unit 140 in step S120. In response to receiving the contract modification request, the contract management unit 140 updates the contract plan ID and contract plan name associated with the user ID of the logged-in user or the device ID of the target image forming apparatus 20 in the user contract plan information list (FIG. 7) or device contract plan information list (FIG. 8), with the plan ID and plan name included in the contract modification request in step S121. In the case the user bears a charge due to the modification of plan, step S121 may be executed after payment of the charge is completed.

In response to the execution of step S104 and subsequent steps, the application list screen 510 corresponding to the newly contracted plan is displayed. In the case the plan includes the selected application, the logged-in user is allowed to use the selected application through the application list screen 510.

In step S114, the following unavailable application notification screen may be displayed instead of the unavailable application notification screen 520a illustrated in FIG. 12. In other words, the screen information transmission unit 111b may generate and transmit screen information of the following unavailable application notification screen.

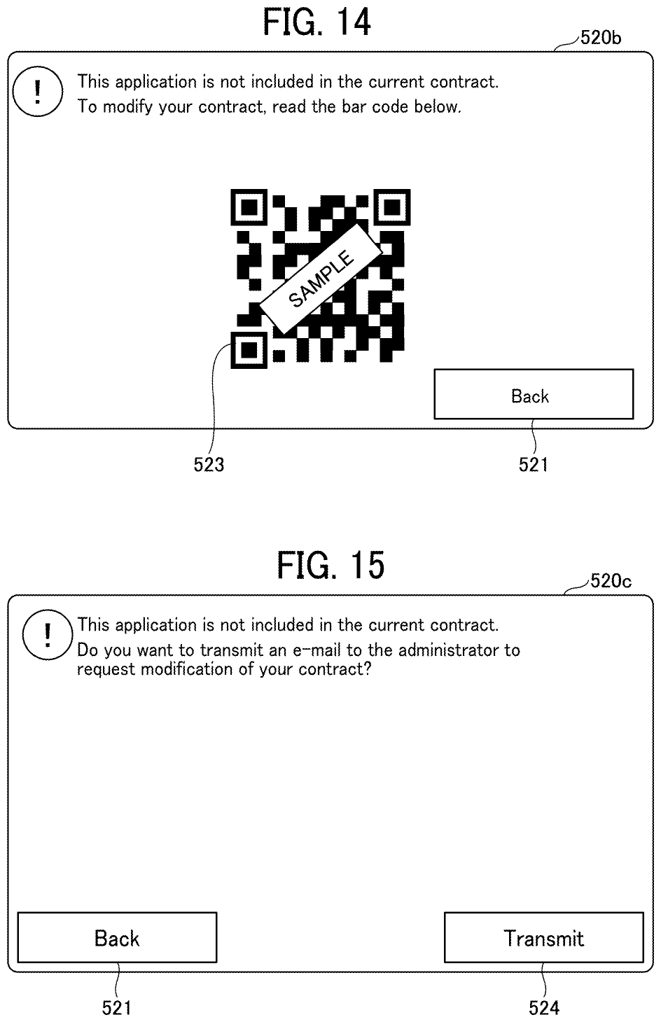

FIG. 14 is a diagram illustrating a first modification of the unavailable application notification screen. In FIG. 14, the same reference numbers are allocated to the same functional units as those of FIG. 12, and redundant description thereof are omitted below.

An unavailable application notification screen 520b illustrated in FIG. 14 includes a two-dimensional code 523 instead of the button 522. The two-dimensional code 523 includes a destination Uniform Resource Locator (URL) of the acquisition request for the contract modification screen in step S116. The logged-in user causes a mobile terminal such as a smartphone to read the two-dimensional code 523, thereby causing the mobile terminal to execute step S116. Accordingly, the contract modification screen is displayed on the mobile terminal. As a result, the logged-in user can use the mobile terminal having higher operability than the control panel 22 of the image forming apparatus 20 to perform contract modification operations.

FIG. 15 is a diagram illustrating a second modified example of the unavailable application notification screen. In FIG. 15, the same reference numbers are allocated to the same functional units as those of FIG. 12, and redundant description thereof are omitted below.

An unavailable application notification screen 520c illustrated in FIG. 15 includes a button 524 instead of the button 522. The button 524 is a button for receiving an instruction to send an e-mail requesting the administrator who has the authority to modify the contract to modify the contract. By using the unavailable application notification screen 520c, the logged-in user who does not have the authority to modify the contract requests an appropriate administrator to modify the contract. The contract and user information storage unit 170 may store attribute information that enables determination of whether the user has the authority to modify the contract for each user, and the screen information transmission unit 111b may switch screen information to be generated based on the attribute information. Based on the determination that the logged-in user has the authority to modify the contract according to the attribute information, the screen information transmission unit 111b may generate, for example, the screen information of the unavailable application notification screen 520a or the unavailable application notification screen 520b. Alternatively, based on a determination that the logged-in user has the authority to modify the contract according to the attribute information, the screen information transmission unit 111b may generate screen information for the unavailable application notification screen 520c. Accordingly, the unavailable application notification screen to be displayed is modified according to the attribute of the user.

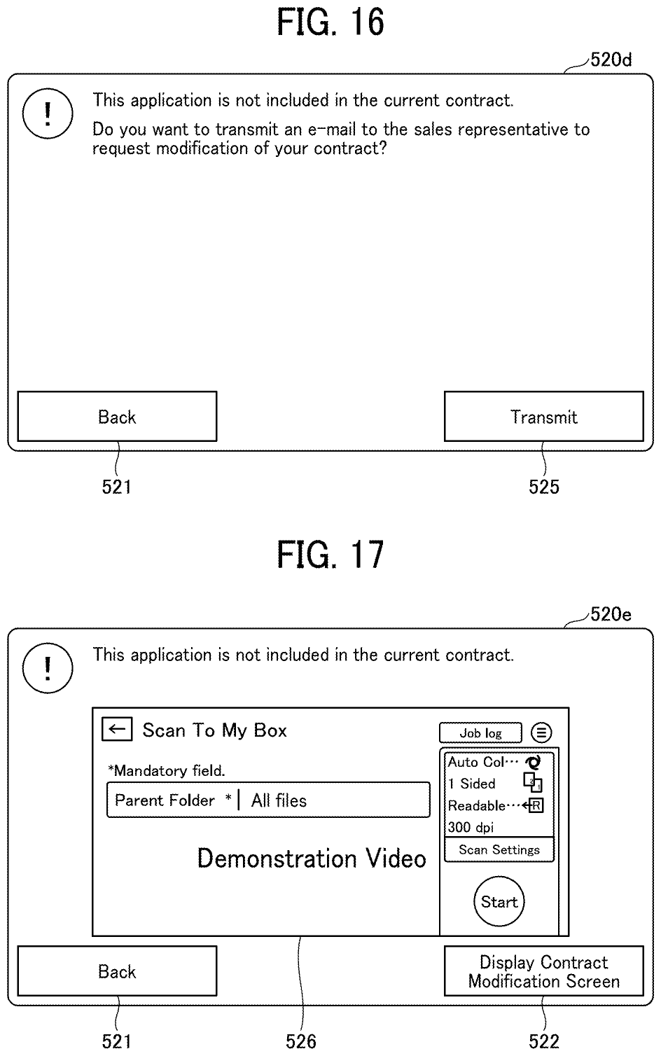

In addition, the unavailable application notification screen may be modified according to an attribute of the application. An example of the attribute is a form of application sales (direct sales, indirect sales). For example, in the case of direct sales, the unavailable application notification screen 520c of FIG. 15 may be displayed in order to contact the administrator, but in the case of direct sales, contacting a sales representative may be preferred. Accordingly, in the case the selected application is purchased from the indirect sales, the unavailable application notification screen illustrated in FIG. 16 may be displayed.

FIG. 16 is a diagram illustrating a second modified example of the unavailable application notification screen. In FIG. 16, the same reference numbers are allocated to the same functional units as those of FIG. 12, and redundant description thereof are omitted below. An unavailable application notification screen 520d illustrated in FIG. 16 includes a button 525 instead of the button 522. The button 525 is a button for receiving an instruction to send an e-mail requesting the sales representative to modify the contract.

FIG. 17 is a diagram illustrating a fourth modified example of the unavailable application notification screen. In FIG. 17, the same reference numbers are allocated to the same functional units as those of FIG. 12, and redundant description thereof are omitted below.

An unavailable application notification screen 520e illustrated in FIG. 17 includes a demonstration video display area 526. The demonstration video display area 526 is an area for displaying a demonstration video presenting how to use the selected application. By referring to the demonstration video, the logged-in user understands how to use the selected application clearly. As a result, the logged-in user is motivated to modify the contract to use the selected application.

The unavailable application notification screens 520a to 520e are hereinafter referred to as an “unavailable application notification screen 520” when the screens are not distinguished from each other.

Alternatively, instead of immediately displaying the unavailable application notification screen 520 in response to pressing of the unavailable application button, the selected application may be available with usage restriction.

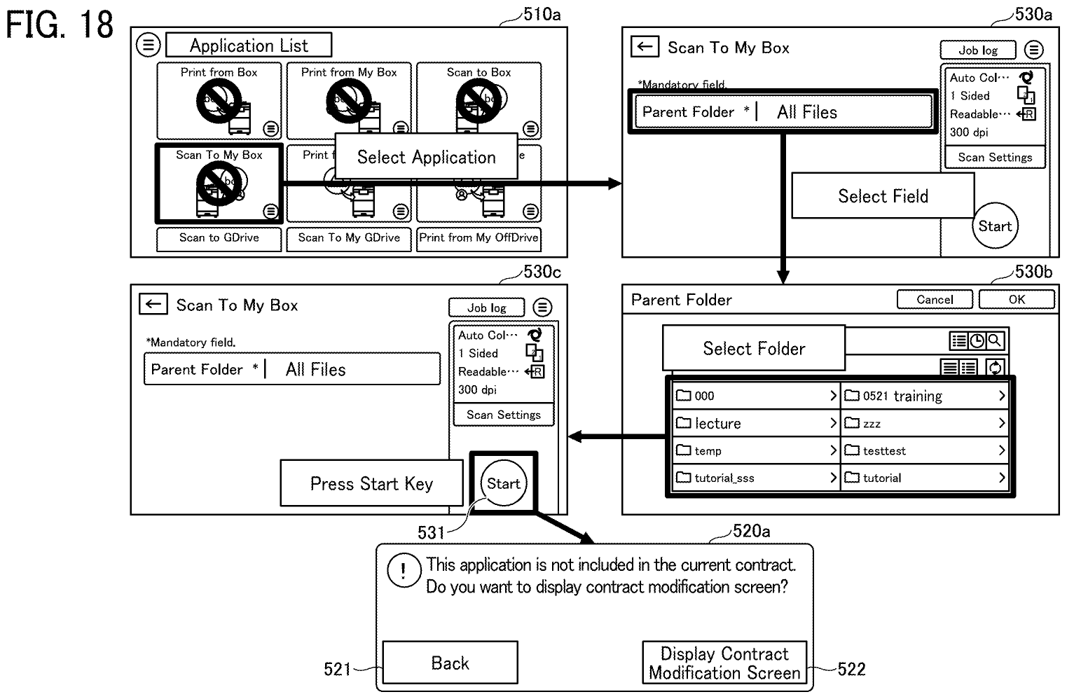

FIG. 18 is a diagram illustrating an example in which use of the selected application is allowed with the usage restriction.

In response to a pressing of any of the unavailable application buttons on the application list screen 510a, the browser 221 downloads the screen information of the selected application from the application management unit 111 and displays the setting screen regarding the selected application. In the example of FIG. 18, the selection application is an application that uploads image data scanned from a paper document to “My Box”, which is a cloud storage. Accordingly, the browser 221 first displays a setting screen 530a including a field for selecting an upload destination folder. In response to a pressing of the field, the browser 221 displays a setting screen 530b. In response to selection of an upload destination folder on the setting screen 530b, the browser 221 displays a screen 530c including a start button 531 for receiving an execution instruction. In response to a pressing of a start button 531, the browser 221 displays the unavailable application notification screen 520a.

By allowing the use of the selected application with usage restriction, the logged-in user may obtain a better understanding of the selected application than the demonstration video.

In the above description, a display to enable identification of whether the usage of the application is allowed based on the contract plan, and the display and the like of the unavailable application notification screen 520 in the case the selected application is not allowed to be used on the application list screen 510 in the situation where the user executes the application are described.

On the other hand, the service providing system 10 may provide a dedicated site (hereinafter referred to as a “common setting site”) for enabling presetting of applications and cooperation with the cloud storage services.

The common setting site is accessed from an information processing terminal other than the image forming apparatus 20, such as the information processing apparatus 30, and the application list screen is displayed on the common setting site in the same manner as on the control panel 22 of the image forming apparatus 20. Accordingly, whether the usage of each application is allowed based on the contract plan may be indicated on the application list screen displayed on the common setting site.

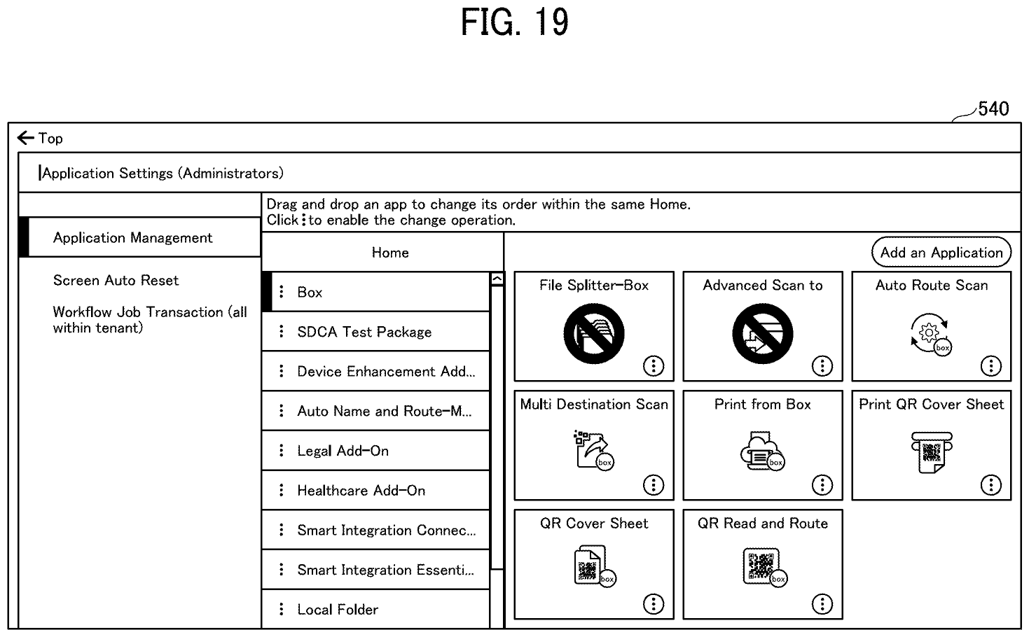

FIG. 19 is a diagram illustrating a display example of the application list screen on the common setting site. In an application list screen 540 illustrated in FIG. 19, the prohibition mark is displayed on the unavailable application button as in the application list screen 510a illustrated in FIG. 10. Note that the procedure for displaying the application list screen 540 may be the same as in FIG. 6. However, the information processing terminal operated by the user is not limited to the image forming apparatus 20.

Here, in the case the user (login user) browsing the common setting site is the administrator, the unavailable application notification screen that leads to the contract modification screen may be displayed in response to pressing the unavailable application button.

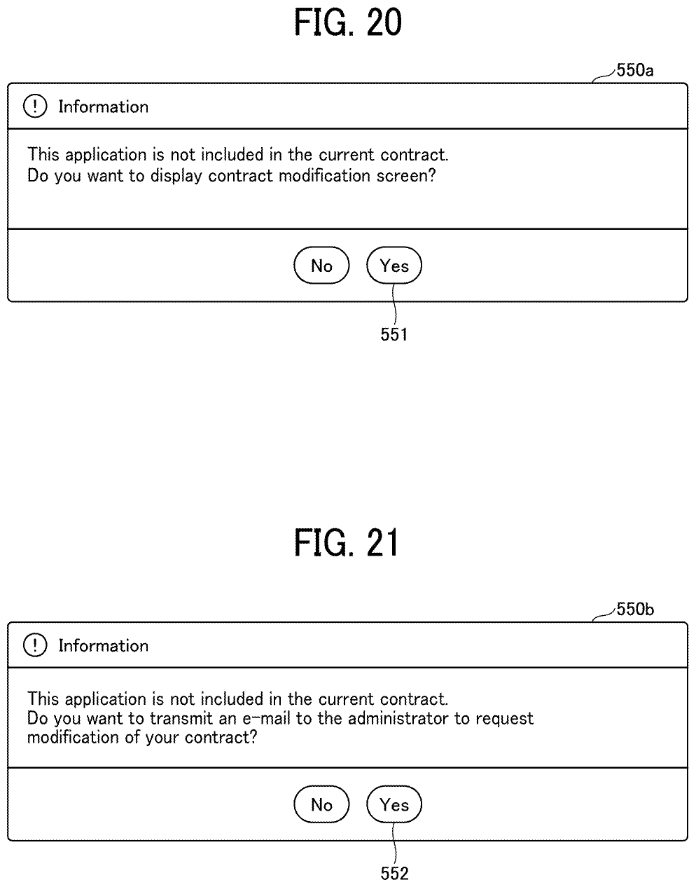

FIG. 20 is a diagram illustrating a first display example of the unavailable application notification screen on the common setting site.

The unavailable application notification screen 550a illustrated in FIG. 20 includes the same function as the unavailable application notification screen 520a illustrated in FIG. 12. In response to operation of a button 551, the process after step S115 in FIG. 6 is executed.

On the other hand, in the case the user (logged-in user) browsing the common setting site is a general user who does not have the authority to modify the contract, the unavailable application notification screen that leads to a request to the administrator to modify the contract may be displayed in response to the pressing of the unavailable application button.

FIG. 21 is a diagram illustrating a second display example of the unavailable application notification screen on the common setting site.

An unavailable application notification screen 550b illustrated in FIG. 21 includes the same function as the unavailable application notification screen 520c illustrated in FIG. 15. In response to operation of a button 552, an e-mail requesting modification of the contract is sent to the administrator who has the authority to modify the contract.

As described above, according to the present embodiment, the application that is not allowed to be used by the user are selectably displayed on the application list screen 510 or the application list screen 540. Accordingly, the user perceives the existence of the application that is not allowed to be used due to the restriction of the plan applied to the user. As a result, the user may be made interested in the application. Accordingly, utilization of the application may be promoted.

Further, in response to operation of the unavailable application button, the unavailable application notification screen is displayed, and further, the contract modification screen is displayed. The operation for enabling use of the unavailable application (for example, the operation for modifying the contract plan) is received on the unavailable application notification screen or the contract modification screen. As a result, an operation procedure for making the unavailable application available is clearly presented to the user and the burden of such operation is reduced. In addition, an increase in contract rate of plans that are not contracted is expected.

An information processing terminal (device) other than the image forming apparatus 20 may be used instead of the image forming apparatus 20. For example, an output device such as a projector (PJ), an interactive whiteboard (a whiteboard having an electronic whiteboard function capable of mutual communication (IWB)), a digital signage, a head up display (HUD) device, an industrial machine, an imaging device, a sound collecting device, a medical device, a network home appliance, a notebook PC, a mobile phone, a smartphone, a tablet terminal, a game console, a personal digital assistant (PDA), a digital camera, a wearable PC, a desktop PC, and the like may be used instead of the image forming apparatus 20.

The apparatuses or devices described in one or more embodiments are just one example of plural computing environments that implement the one or more embodiments disclosed herein.

In some embodiments, the service providing system 10 includes multiple computing devices, such as a server cluster. The plurality of computing devices is configured to communicate with one another through any type of communication link, including a network, shared memory, etc., and perform the processes disclosed herein. Similarly, image forming apparatus 20 may include multiple computing devices configured to communicate with one another.

In the present embodiment, the service providing system 10 is an example of an information processing apparatus. The image forming apparatus 20 is an example of the information processing terminal. The application list screen 510 is an example of the first screen. The unavailable application notification screen and the contract modification screen are examples of the second screens.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. An information processing apparatus comprising:
circuitry configured to:
identify a user of an information processing terminal;
transmit to the information processing terminal, first screen information for displaying a first screen on a display, the first screen presenting, from among a plurality of applications, a first application available to the user and a second application unavailable to the user in a distinguishable manner;
control execution of the first application selected on the first screen; and
in response to selection of the second application on the first screen, transmit to the information processing terminal, second screen information for displaying on the display, a second screen for receiving an operation for enabling use of the second application.

2. The information processing apparatus of claim 1, wherein
the second application is an application unavailable to the user based on a contract for use of application, and
the second screen is a screen that receives an operation for modifying the contract for use of application.

3. The information processing apparatus of claim 1, wherein
the second screen is modified according to an attribute of the user.

4. The information processing apparatus of claim 1, wherein
the second screen is modified according to an attribute of the second application selected by the user.

5. The information processing apparatus of claim 1, wherein
the second screen is a screen including a two-dimensional barcode.

6. The information processing apparatus of claim 1, wherein
the second screen displays a video related to the second application.

7. An information processing system comprising:
the information processing apparatus of claims 1; and
the information processing terminal.

8. An information processing system comprising:
circuitry configured to:
identify a user of an information processing terminal;
display at the information processing terminal a first screen presenting, from among a plurality of applications, a first application available to the user and a second application unavailable to the user in a distinguishable manner;
control execution of the first application selected on the first screen; and
in response to selection of the second application on the first screen, display at the information processing terminal, a second screen for receiving an operation for enabling use of the second application.

9. An information processing method comprising:
identifying a user of an information processing terminal;
transmitting to the information processing terminal, first screen information for displaying a first screen on a display, the first screen presenting, from among a plurality of applications, a first application available to the user and a second application unavailable to the user in a distinguishable manner;
controlling execution of the first application selected on the first screen; and
in response to selection of the second application on the first screen, transmitting to the information processing terminal, second screen information for displaying on the display, a second screen for receiving an operation for enabling use of the second application.
